(19) United States
(12) Patent Application Publication
(10) Pub. No.: US 2013/0127186 A1
(43) Pub. Date: May 23, 2013

(54) COUPLING ARRANGEMENT

(71) Applicant: David Martin Stuckey, Hawthorn (AU)

(72) Inventor: David Martin Stuckey, Hawthorn (AU)

(21) Appl. No.: 13/696,007

(22) PCT Filed: Apr. 28, 2011
(86) PCT No.: PCT/AU11/00488

§ 371 Date: Dec. 7, 2012

(30) Foreign Application Priority Data
May 5, 2010 (AU) 2010901917

(51) Int. Cl. E05B 3/08; F16B 33/00; E05B 1/00

(52) U.S. Cl. CPC E05B 3/08; E05B 1/00; F16B 33/00
USPC 292/336.3; 403/343; 411/366.1

(57) ABSTRACT

A two-part coupler suitable for attaching a compression latch accessory (200) an actuator (100) comprising a first coupler member (110) securable to the actuator and being adapted to co-act directly with a second coupler member (220) securable to the accessory, wherein in use rotation of the actuator activates the accessory.

### FIELD OF THE INVENTION

The present invention relates to a coupling arrangement for attaching an accessory to an actuator of a closure system. Such closure systems may be used with any access point, such as a door, lid, cover or hatch on a room, locker, storage container, compartment, transport box, bag or the like.

### BACKGROUND OF THE INVENTION

Closure systems are usually sold as a combination of an actuator together with a variety of latches and/or locking mechanisms, which have already been attached thereto. One example known in the art is an actuator including a compression latch formed integral therewith, which is particularly useful where an actuator in the form of a handle is applied to an access point, which includes a seal. There is a requirement upon opening such a handle for the latch or cam attached to the handle to be first moved outwardly away from the seal prior to rotation of the handle, since the seal could prevent sufficient clearance between the latch or cam and the surface to which the handle is attached. As a result, rotation of the latch or cam could cause scratching of and damage to the surface to which the handle is attached. Conversely, upon closing the handle, the latch or cam needs to be turned and then drawn inwardly, to ensure that a seal is formed. This is known as a lift-and-turn mechanism.

Closure systems having compression latches formed integrally with a variety of actuators are known in the art. However, the tooling costs of providing a compression latch attached to each different closure system are enormous and for markets with relatively small product runs, the costs are prohibitive.

The present invention seeks to enable an accessory, one example of which is a compression latch having a lift-and-turn mechanism, to be retrofitted to any known closure system or locking arrangement at a fraction of the cost. Using the coupling arrangement of the present invention, such a lift-and-turn mechanism, for example, can be tooled separately and then later coupled to any known actuator. The present invention therefore seeks to at least ameliorate some of the problems associated with the prior art by providing a means to accessorise any known actuator.

### SUMMARY OF THE INVENTION

According to the present invention, there is provided a two-part coupler for attaching an accessory to an actuator comprising a first coupler member securable to the actuator and being adapted to coact directly with a second coupler member securable to the accessory, wherein in use rotation of the actuator activates the accessory.

Preferably, the actuator comprises an attachment means for securing the first coupler member to the actuator. In one preferred form, the attachment means preferably comprises an externally threaded receiving end portion to receive the first coupler member wherein once received, the first coupler member is secured to the attachment means by a fastening means, which is most preferably in the form of a nut. In another preferred form, the attachment means comprises an internally threaded receiving end portion, wherein the first coupler member is secured to the attachment means, most preferably by a bolt.

The second coupler member is preferably adapted to comprise a contact portion which is of a substantially castellated configuration. This substantially castellated contact portion more preferably mates with a contact portion of the first coupler member comprising at least one cut-out region. The contact portion of the second coupler member further more preferably consists of a substantially cylindrical body having an open mouth portion within which the end portion of the attachment means is substantially receivable. The contact portion of the second coupler member more preferably comprises at least one merlon. In a most preferred embodiment, the contact portion of the second coupler member comprises three merlons and the first coupler member comprises three corresponding cut-out regions.

The scope of the present invention also extends to a coupling arrangement comprising the two-part coupler of the invention, wherein the coupling arrangement includes an anti-rotation plate which is removably attached to the actuator and releasably securable to the accessory. The anti-rotation plate substantially restricts independent rotational movement of the accessory with respect to the actuator.

In one preferred form, the accessory is a compression latch accessory which comprises a dog-clutch mechanism. However, the present invention is by no means limited to the accessory being of the compression latch type and any suitable accessory is envisaged and is intended to be included in the scope of the present invention. Using the two-part coupler of the present invention, a compression latch accessory can be readily retrofitted to any suitable actuator.

The scope of the present invention also extends to a closure system in which any known actuator is employed, inducting but not limited to a swing handle assembly, a quarter-turn assembly or a T-bar handle assembly. The closure system may be used with any lockable access point such as a door, lid, cover or hatch on a room, locker, storage container, compartment, transport box, bag or the like. In a preferred aspect, the present invention provides a closure system, where the actuator is a swing handle and by using the two-part coupler of the invention, a compression latch accessory, for example, can be readily retrofitted to a swing handle assembly. In some preferred forms, the closure system can include a tray in which the actuator is mountable.

### DESCRIPTION OF THE DRAWINGS

Other features and advantages of one or more preferred embodiments of the present invention will be readily apparent to one of ordinary skill in the art from the following written description with reference to, and used in conjunction with, the accompanying drawings.

FIG. 1 shows several views of a closure system comprising a swing handle actuator and a compression latch accessory attached thereto, according to exemplary embodiments of the present invention. Panels A and C show the closure system from above and below, respectively, and panel B shows the closure system mounted in a tray.

FIG. 2 shows several views of a closure system comprising a quarter-turn actuator and a compression latch accessory attached thereto, according to exemplary embodiments of the present invention. Panels A and C show the closure system from above and below, respectively, and panel B shows the closure system mounted in a tray.

FIG. 3 shows internal components of the exemplary embodiments of the present invention illustrated in FIG. 1.

FIG. 4 shows internal components of the exemplary embodiments of the present invention illustrated in FIG. 2.

FIGS. 5A and 5B show two exemplary embodiments of the attachment of the first coupler member to the attachment means of the actuator, according to the present invention.

FIG. 6 shows a cut-away view of the coupling arrangement of the present invention, illustrated in FIGS. 1B and 3B. In particular, FIG. 6 shows the relative positioning of the contact portion of the second coupler member and the receiving end portion of the attachment means during assembly. The second coupler member is shown disconnected from the coupler member.

FIG. 7 shows a cut-away view of the coupling arrangement of the present invention illustrated in FIGS. 4A and 4B. In particular, FIG. 7 shows the relative positioning of the accessory housing and the actuator. The second coupler member is shown disconnected from the coupler member.

### DETAILED DESCRIPTION OF THE INVENTION

Referring to all the drawings wherein like reference numerals designate like or corresponding parts throughout the several views. The following description refers to the specific, illustrated embodiments of the present invention and is in no way intended to limit the scope of the present invention to the specific, illustrated embodiments.

The present invention provides a two-part coupler 110,210 for attaching an accessory 200 to an actuator 100 comprising a first coupler member 110 securable to the actuator 100 and being adapted to coact directly with a second coupler member 210 securable to the accessory 200, wherein in use rotation of the actuator 100 activates the accessory 200.

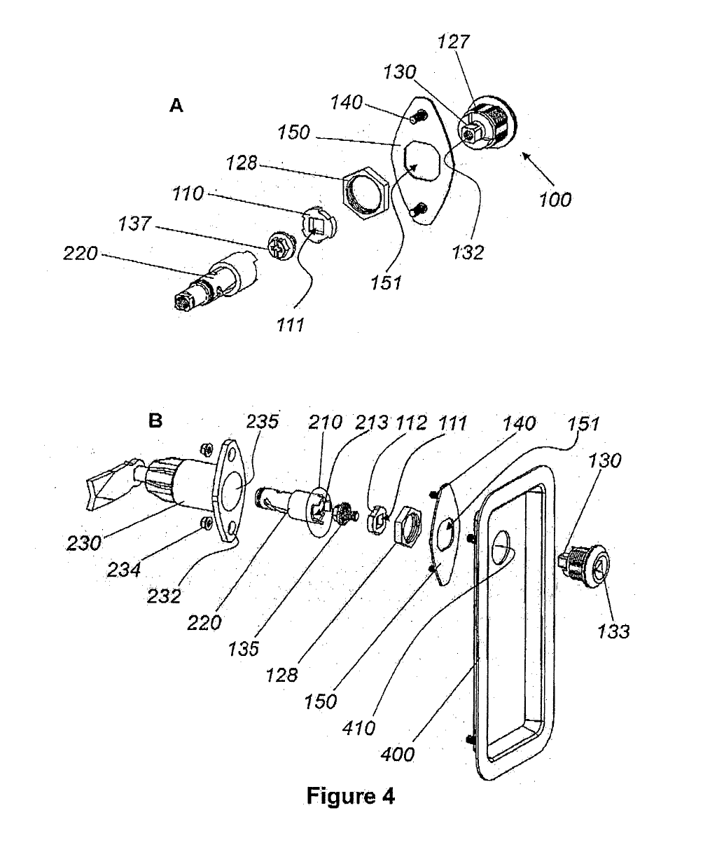

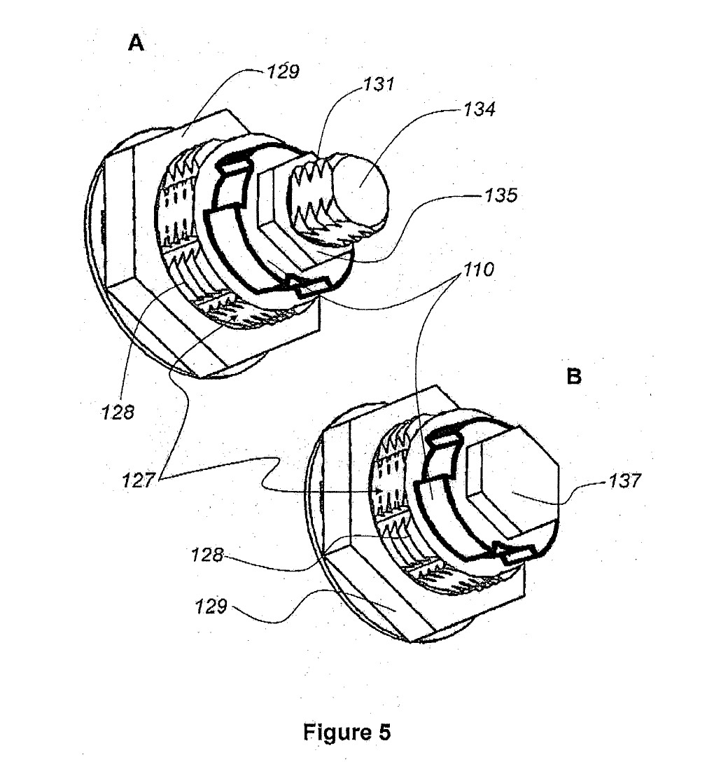

The invention also provides a coupling arrangement utilising the two-art coupler for operably connecting an actuator 100 to an accessory 200 for use in a closure system 300, the actuator 100 comprising a attachment means 130 to receive a first coupler member 110. In one form, as shown in FIG. 5A, the attachment means 130 comprises an externally threaded receiving end portion 131 to receive the first coupler member 110 thereon through opening 111, wherein once received, the first coupler member 110 is secured to the attachment means 130 by a fastening means, which is most preferably in the form of a nut 135. In another form, as shown in FIG. 4A, the attachment means 130 comprises an internally threaded receiving end portion 132, wherein the first coupler member 110 is secured directly to the attachment means 130, most preferably by a bolt 137.

Various alternative means of securing the first coupler member 110 to the attachment means 130 can be used. Alternative examples of include, but are not limited to, a circlip engaging a groove around the attachment means 130 substantially adjacent to the first coupler member 110; or a roll-pin passing through an opening (not shown) in attachment means 130 located substantially adjacent to first coupler member 110.

The second coupler member 220 is preferably adapted to comprise a contact portion 210 which is of a substantially castellated configuration. This substantially castellated contact portion 210 more preferably mates with a contact portion of the first coupler member 110 comprising at least one cutout region 112. The contact portion 210 of the second coupler member 220 further more preferably consists of a substantially cylindrical body having an open mouth portion 213 within which the end portion 134 of the attachment means 130 is substantially receivable. The contact portion 210 of the second coupler member 220 more preferably comprises at least one merlon 212. In a most preferred embodiment, the contact portion 210 of the second coupler member 220 comprises three merlons 212 and the first coupler member 110 comprises three corresponding cut-out regions 112.

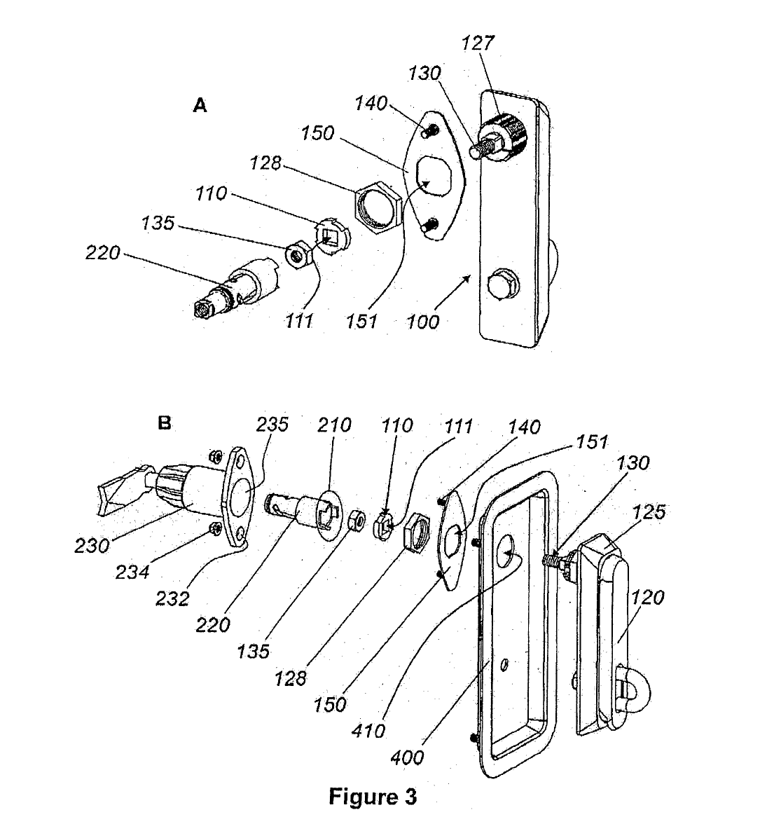

In one embodiment of the present invention, as shown in FIG. 3, the actuator 100 is a swing handle assembly, comprising a swing handle member 120 and an attachment means 130. The first coupler member 110 is releasably secured to the attachment means 130, so that rotation of the handle member 120 results in concomitant rotation of the first coupler member 110. In another embodiment, the actuator is a quarter turn as is shown in Figures A and B.

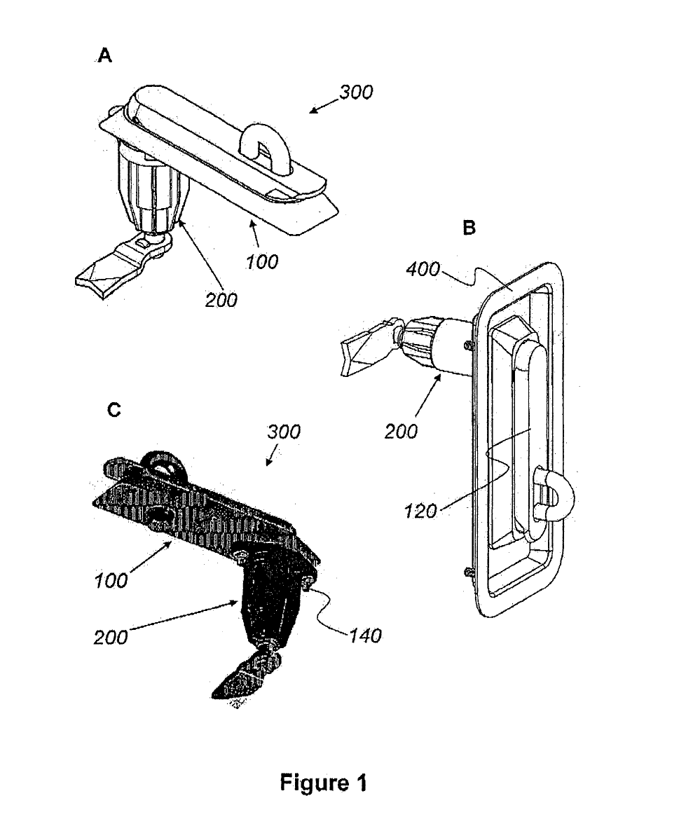

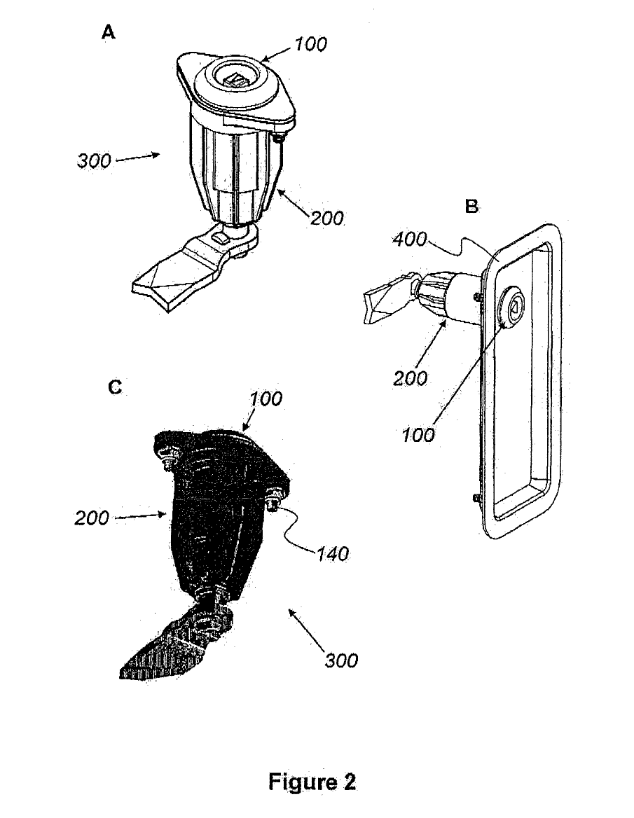

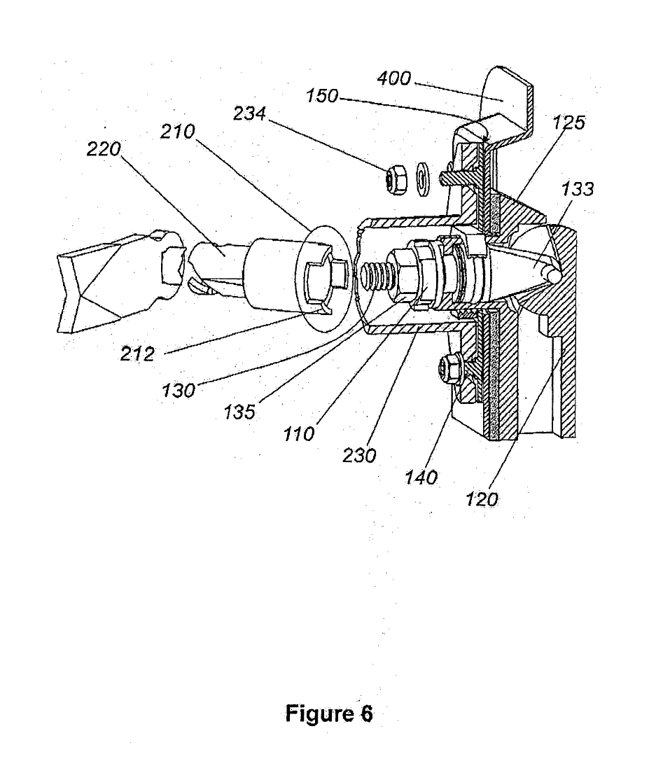

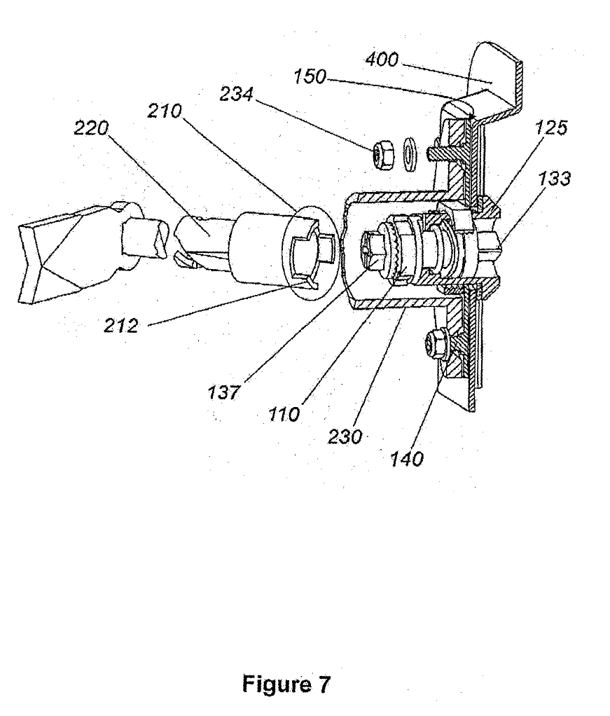

It is envisaged that where the actuator 100 is a swing handle, the actuator 100 includes a base 125, which base 125 comprises a mounting means 127 for mounting the actuator 100 upon a door (not shown), or the like. In use, mounting means 127 of actuator 100 is first inserted into an opening (not shown) in the door. The attachment means 130 is received in and is rotatable within, mounting means 127. The handle 120 is attached to, attachable to, or engageable with, a first end 133 of the attachment means 130, thereby connecting the handle member 120 (when present) on one side of the door and the first coupler member 110 received by attachment means 130 on the other side of the door. Preferably, the actuator 100 is selected from, but not limited to, a swing handle assembly (see FIGS. 1, 3 and 6), a T-bar handle assembly (not shown) and a quarter-turn assembly (See FIGS. 2, 4 and 7).

As used herein, the term “handle member” is intended to encompass not only a handle as typically understood by the skilled addressee, but also a handle or key that is used to operate a quarter-turn. Furthermore, the handle or key for a quarter-turn assembly is engageable with the first end 133 of the attachment means 130, rather than being attached to the first end 133 of the attachment means 130.

Typically, the mounting means 127 preferably includes a substantially externally threaded portion 128 onto which a locking nut 129 is receivable for securing the actuator 100 to a door or the like, by sandwiching the door between the locking nut 129 and the base 125 of the actuator 100. Generally, the mounting means 127 will be substantially non-circular in cross-section, so that it can be mounted onto the door using a substantially non-circular mounting hole (not shown) and thereby substantially prevent rotation of the base 125 relative to the door when the actuator 100 is in use.

Preferably, the actuator 100 further includes at least one threaded portion 140 to facilitate attachment of the accessory 200 to actuator 100. In the illustrated embodiments of the present invention, the at least one threaded portion 140 may comprise at least one threaded stud. In some embodiments, the at least one threaded portion 140 may be secured directly to or be formed integral with the base 125. Alternatively, the at least one threaded portion 140 may comprise a threaded hole (not shown) in the base of the actuator 100 into which a bolt or screw may be received to fix the accessory 200 thereto. In one embodiment, as described above, the at least one threaded portion 140 is a threaded stud.

In a further alternative embodiment, the coupling arrangement of the invention includes an anti-rotation plate 150 which is removably attached to the actuator 100 and releasably securable to the accessory 200. The anti-rotation plate 150 substantially restricts independent rotational movement of the accessory 200 with respect to the actuator 100. The at least one threaded portion 140 of the actuator may be secured to or be formed integral with the anti-rotation plate 150. In one preferred form, the anti-rotation plate 150 may be mountable on the mounting means 127 via a substantially non-circular mounting hole 151 formed therein to substantially restrict rotation of the anti-rotation plate 150 with respect to the actuator 100. Preferably, the anti-rotation plate 150 may be secured to the actuator 100 by the use of a locking nut 129, which sandwiches the door and anti-rotation plate 150 between the locking nut 129 and base 125.

In another embodiment (not shown), accessory 200 may also be mounted directly upon base 125 of actuator 100 and substantially secured thereto via the at least one threaded portion located on base 125. In order to attach the accessory 200 to the actuator 100, the at least one threaded portion 140 is passed through an opening 232 in the accessory housing 230 to which a fastener 234 is applied for fixing the accessory 200 to the actuator 100.

In certain embodiments, such as illustrated In FIGS. 1B, 2B, 3B, 4B, 6 and 7, the closure system 300 may be mounted in a tray 400. In such embodiments, the mounting means 127 passes through an opening 410 in the tray 400. It is envisaged that the at least one threaded portion 140 in the form of one or more threaded studs may be situated on an anti-rotation plate 150 or be formed integral therewith as discussed above, or may be attached directly to the tray 400 (not illustrated).

The present invention provides a coupling arrangement whereby various types of actuator/s 100 may be matched with various types of accessory 200, wherein in use the accessory 200 is activated by the actuator 100. For example, as illustrated, the accessory 200 may be a compression latch. It is necessary for the accessory 200 to engage with the actuator 100, so that rotation of the attachment means 130, for example, via the handle 120, is translated into the required function. It is the coaction or engagement of the accessory 200 with the actuator 100 that results in the dog-clutch mechanism discussed above, whereby rotation of the attachment means 130 causes activation of the accessory 200.

In one preferred form, the accessory 200 is a compression latch accessory as illustrated in FIG. 4B, which comprises a dog-clutch mechanism. However, the present invention is by no means limited to the accessory being of the compression latch type and any suitable accessory is envisaged and is intended to be included in the scope of the present invention. Using the two-part coupler of the present invention, a compression latch accessory can be readily retrofitted to any suitable actuator.

The closure system may be used with any lockable access point such as a door, lid, cover or hatch on a room, locker, storage container, compartment, transport box, bag or the like. In a preferred aspect, the present invention provides a closure system, where the actuator is a swing handle and by using the two-part coupler of the invention, a compression latch accessory, for example, can be readily retrofitted to a swing handle assembly. In some preferred forms, the closure system can include a tray in which the actuator is mountable.

The functional components of the accessory 200 are preferably contained within an accessory housing 230. The accessory housing 230 is preferably adapted to permit attachment of the accessory 200 to the actuator 100, and thereby result in engagement of the dog-clutch mechanism. Such adaption may include, but not be limited to, holes 232 for receiving the at least one threaded portion 140 described above and a cut-out region 235 into which the mounting means 127 may be at least partially received.

Accordingly, in a specific embodiment, the present invention provides a compression latch closure system, comprising an actuator 100 substantially as herein described and a compression latch accessory 200, wherein the accessory 200 is functionally coupled to the actuator 100 via a dog-clutch mechanism comprising a first coupler member 110 and a mating portion 210 of a second coupler member 220, and wherein the compression latch accessory 200 is attached to the actuator 100 via an at least one threaded portion 140.

When a “Markush” group or other grouping is used herein, all individual members of the group and all combinations and sub-combinations possible of the group members are intended to be individually included in the disclosure. Every combination of components described or exemplified herein can be used to practice the invention, unless otherwise stated.

Where the terms “comprise”, “comprises”, comprised” or “comprising” are used in this specification, they are to be interpreted as specifying the presence of the stated features, integers, steps or components referred to, but not to preclude the presence or addition of one or more other feature, integer, step, component or group thereof. The invention illustratively described herein suitably may be practiced in the absence of any element or elements, limitation or limitations which is not specifically disclosed herein.

Further, any prior art reference or statement provided in the specification is not to be taken as an admission that such art constitutes, or is to be understood as constituting, part of the common general knowledge.

One of ordinary skill in the art will appreciate that materials and methods, other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by examples, preferred embodiments and optional features, modification and variation of the concepts herein disclosed may be resorted to by those skilled in the art, and that such modifications and variations are considered to be within the scope of this invention as defined by the appended claims.

1. A coupler for functionally coupling a replaceable accessory to an actuator comprising:
a first coupler member;
a second coupler member; and
an anti-rotation plate,
wherein the first coupler member being securable to the actuator is adapted to coact directly with a second coupler member which is releasably securable to the accessory; and wherein upon securing the accessory to the anti-rotation plate independent rotational movement of the accessory with respect to the actuator is substantially restricted.

2. The coupler of claim 1, wherein the actuator comprises an attachment means for securing the first coupler member to the actuator.

3. The coupler of claim 2, wherein the attachment means comprises either an externally- or an internally-threaded receiving end portion to receive the first coupler member and wherein once received, the first coupler member is secured to the attachment means.

4. The coupler of claim 3, wherein a contact portion of the second coupler member is of a substantially castellated configuration and a mating contact portion of the first coupler member comprises at least one cut-out region.

5. The coupler of claim 4, wherein the contact portion of the second coupler member further consists of a substantially cylindrical body having an open mouth portion within which the end portion of the attachment means is substantially receivable.

6. The coupler of claim 5, wherein the contact portion of the second coupler member comprises at least one merlon.

7. The coupler of claim 6, wherein the contact portion of the second coupler member comprises three merlons and the first coupler member comprises three corresponding cut-out regions.

8. The coupler of claim 3, wherein the first coupler member is secured to the attachment means by a fastening means, wherein when the end portion is externally threaded the fastening means is a nut and when the end portion is internally threaded, the fastening means is a bolt.

9. A coupling arrangement comprising the coupler of claim 1, further comprising the actuator and the accessory.

10. The coupling arrangement of claim 9, wherein the accessory is a compression latch accessory.

11. A closure system incorporating the coupling arrangement of claim 9, wherein the actuator is selected from a swing handle assembly, a quarter-turn assembly or a T-bar handle assembly.

12. The closure system of claim 11, wherein the actuator is a swing handle assembly.

13. The closure system of claim 12, wherein the swing handle assembly is mounted in a tray.

14. The closure system of claim 11, wherein the actuator is a quarter-turn assembly.

15. The closure system of claim 11, wherein the actuator is a T-bar handle assembly.

16. A closure system incorporating the coupling arrangement of claim 10, wherein the actuator is selected from a swing handle assembly, a quarter-turn assembly or a T-bar handle assembly.
